(19) United States
(12) Patent Application Publication
(10) Pub. No.: US 2009/0027514 A1
(43) Pub. Date: Jan. 29, 2009

(54) IMAGE PICKUP APPARATUS AND METHOD

(76) Inventor: Toshio Katano, Miyagi (JP)

Correspondence Address: BIRCH STEWART KOLASCH & BIRCH, PO BOX 747, FALLS CHURCH, VA, 22040-0747, US

(21) Appl. No.: 12/136,524

(22) Filed: Jun. 10, 2008

(30) Foreign Application Priority Data
Jul. 26, 2007 (JP) 2007-194471

(51) Int. Cl. H04N 9/73

(52) U.S. Cl. 348/223.1

(57) ABSTRACT

A digital still camera has a CCD image sensor, and picks up an image to produce an image signal. Colorimetric sensors have a sensor outer surface oriented in a measuring direction being different from a direction of an optical axis of the CCD image sensor, and colorimetrically measure ambient light. Lighting color temperature of the ambient light is determined according to a result of colorimetry. Image color temperature of the image is retrieved according to the image signal. A gain for each of color components is determined according to the lighting color temperature and the image color temperature. The color components of the image signal are amplified with the gain, to adjust white balance. Also, a camera body accommodates the CCD image sensor and the colorimetric sensors. The sensor outer surface is positioned on at least one of an upper surface and a lateral surface of the camera body.

### BACKGROUND OF THE INVENTION

1. Field of the Invention

The present invention relates to an image pickup apparatus and method. More particularly, the present invention relates to an image pickup apparatus and method in which white balance of an image can be adjusted suitably in an automated manner.

2. Description Related to the Prior Art

A digital camera as image pickup apparatus is known in the field of imaging, for example, digital still camera, camera built-in type of cellular phone and the like. An image sensor of CCD or CMOS type is used to pick up an image of an object to convert an image signal into image data of a digital form, which is written to a memory card or other data storage. Auto white balancing is known, and carried out in the digital still camera to adjust the white balance automatically to reproduce color of an object correctly by matching of the color.

Failure in the color balance occurs mainly due to a difference in the color temperature of a light source illuminating the object. To adjust the color balance, input gains for amplifying image data or an image signal output by an image sensor so as to set equal the output levels of the red, green and blue colors in photographing a test object of white or gray as an achromatic color.

JP-A 6-303486 discloses a digital still camera with auto white balancing. The digital still camera has a main image pickup assembly and an auxiliary image pickup assembly for use in the adjustment of focus, exposure and white balance. JP-A 2005-175838 includes a digital still camera including an image sensor and a colorimetric sensor. A first control signal of control of white balance is generated according to colorimetric data. A second control signal of control of white balance is generated according to an image signal from the image sensor. Correction data for color temperature is determined according to the first and second control signals.

According to JP-A 6-303486 and JP-A 2005-175838, the auxiliary image pickup assembly or the colorimetric sensor is directed to the object to measure the color of object light. If the image color temperature of the object light is considerably different from the color temperature of light of the light source illuminating the object, a problem arises in that no suitable white balance is obtained. For example, an object may be a person wearing clothes of a deep red color or deep blue color.

Also, a digital still camera with manual white balancing is also known, in which a user finds a type of a light source, such as daylight, incandescent light, fluorescent light and the like, and inputs information of the light source type to the digital still camera to adjust the white balance. However, it is difficult for ordinary users to use the digital still camera due to requirement of high skill.

### SUMMARY OF THE INVENTION

In view of the foregoing problems, an object of the present invention is to provide an image pickup apparatus and method in which white balance of an image can be adjusted suitably in an automated manner.

In order to achieve the above and other objects and advantages of this invention, an image pickup apparatus includes a solid state image pickup device for image pickup of an image to produce an image signal. At least one colorimetric sensor colorimetrically measures ambient light in a measuring direction being different from a direction of the image pickup of the solid state image pickup device. A lighting color temperature detector determines lighting color temperature of the ambient light according to colorimetric data from the colorimetric sensor. A gain setting unit determines a gain for each of plural color components according to the lighting color temperature and image color temperature of the image obtained from the color components of the image signal. An amplifier amplifies the color components of the image signal with the gain, to adjust white balance.

The measuring direction is substantially perpendicular to the image pickup direction.

The colorimetric sensor is constituted by plural colorimetric sensors.

Furthermore, a body accommodates the solid state image pickup device and the colorimetric sensors. The colorimetric sensors are positioned on an upper surface and a lateral surface of the body.

The plural colorimetric sensors are three colorimetric sensors, and the measuring direction is different between at least two thereof.

The three colorimetric sensors are positioned on respectively the upper surface, a right lateral surface and a left lateral surface of the body.

In a preferred embodiment, furthermore, a body accommodates the solid state image pickup device and the colorimetric sensor. The colorimetric sensor protrudes from an upper surface of the body, and the sensor outer surface is tilted relative to the upper surface.

Two of the colorimetric sensors have the sensor outer surface tilted in measuring directions different from one another.

The gain setting unit determines the gain according to a weighted average with a first weighting factor for the image color temperature and with a second weighting factor for the lighting color temperature, and the first weighting factor is greater than the second weighting factor.

The at least one colorimetric sensor includes first, second and third color filters for passing respectively first, second and third color components of the ambient light being incident. First, second and third photo receptors photoelectrically detect the ambient light from respectively the first, second and third color filters, to output the colorimetric data.

Also, an image pickup method of image pickup of an image with a solid state image pickup device, to produce an image signal, is provided. Ambient light is colorimetrically measured with a sensor outer surface oriented in a measuring direction being different from a direction of an optical axis of the solid state image pickup device. Lighting color temperature of the ambient light is determined according to a result of colorimetry. Image color temperature of the image is retrieved according to the image signal. A gain for each of color components is determined according to the lighting color temperature and the image color temperature. The color components of the image signal are amplified with the gain, to adjust white balance.

Also, a computer executable program for image pickup of an image with a solid state image pickup device, to produce an image signal, is provided. There is a program code for colorimetrically measuring ambient light with a sensor outer surface oriented in a measuring direction being different from a direction of an optical axis of the solid state image pickup device, and for determining lighting color temperature of the ambient light according to a result of colorimetry. A program code is for retrieving image color temperature of the image according to the image signal, and for determining a gain for each of color components according to the lighting color temperature and the image color temperature. A program code is for amplifying the color components of the image signal with the gain, to adjust white balance.

Therefore, white balance of an image can be adjusted suitably in an automated manner, owing to the colorimetry in the measuring direction different from the optical axis of the image pickup.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a digital still camera;

FIG. 2 is a block diagram schematically illustrating a colorimetric sensor;

FIG. 3 is a block diagram schematically illustrating the digital still camera;

FIG. 4 is a flow chart illustrating a sequence of image pickup; and

FIG. 5 is a perspective view illustrating another preferred digital still camera with modified colorimetric sensors.

### DETAILED DESCRIPTION OF THE PREFERRED EMBODIMENT(S) OF THE PRESENT INVENTION

A digital still camera with a solid state image pickup device includes colorimetric sensors of three primary colors to measure the color of ambient light colorimetrically in a direction different from the optical axis. Lighting color temperature of ambient light is calculated according to colorimetric data or tristimulus values from the colorimetric sensors, to adjust the white balance in consideration of the lighting color temperature with image color temperature of a color of an object.

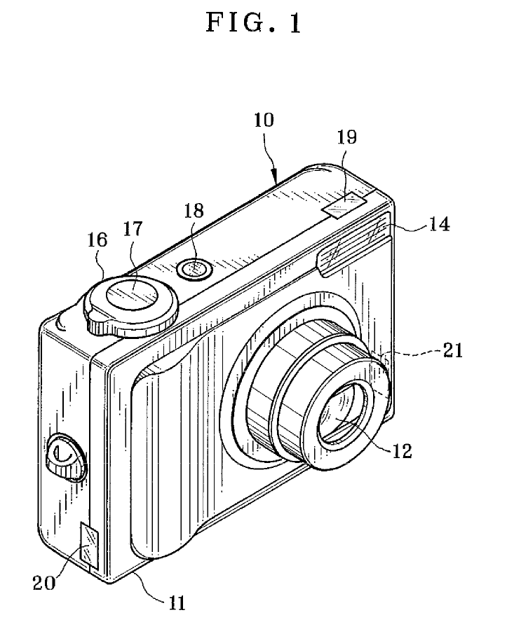

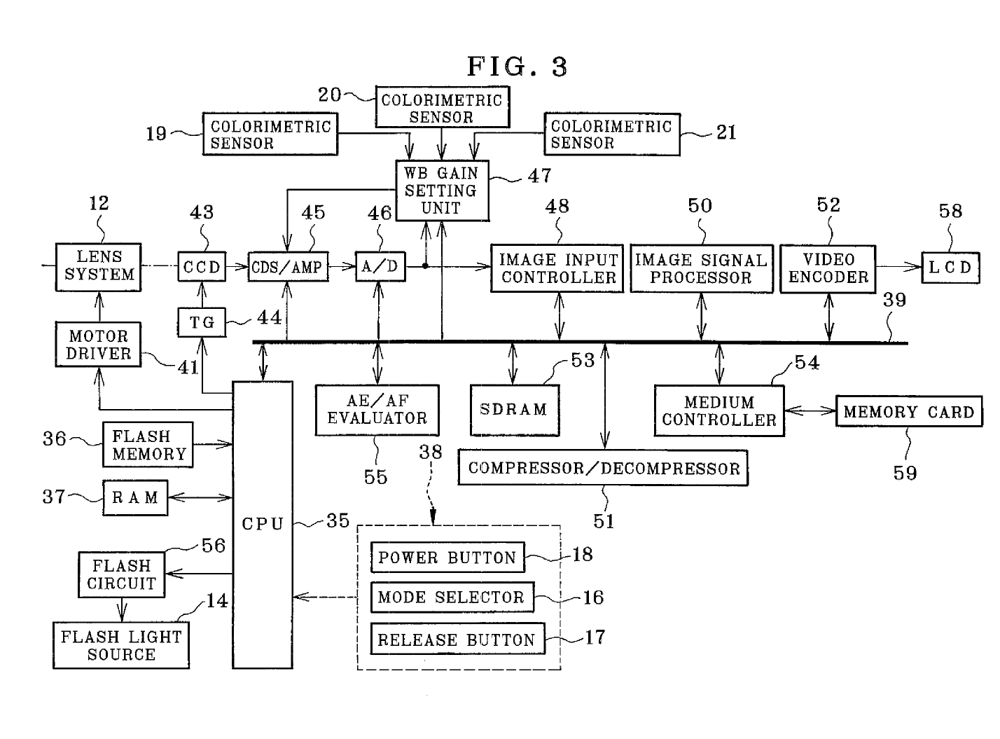

In FIG. 1, a digital still camera 10 as image pickup apparatus includes a camera body 11, a zoom lens system 12, and a flash light source 14. The zoom lens system 12 is a collapsible type. A card slot (not shown) is formed in a left side of the camera body 11 for setting a memory card 59 of FIG. 3.

An upper surface of the camera body 11 has a mode selector 16, a shutter release button 17, a power button 18, and a colorimetric sensor 19 or calorimeter. The mode selector 16 in a ring shape is rotatable for setting a selected one of plural modes. The shutter release button 17 is positioned at the center of the mode selector 16.

The shutter release button 17 is a two step switch depressible in a first position and a second position, and when depressed halfway in the first position, carries out the autofocus control (AF) and the auto exposure control (AE). The settings of the autofocus control (AF) and the auto exposure control (AE) are locked. Then the shutter release button 17 is depressed fully in the second position to take an exposure to pick up an image. An LCD display panel 58 of FIG. 3 and various pushbuttons are disposed on a rear of the camera body 11.

The colorimetric sensor 19 measures a color of ambient light in an upper direction of the camera body 11 which is perpendicular to an optical axis of the image pickup. Colorimetric sensors 20 and 21 or calorimeters are structurally the same as the colorimetric sensor 19, and are disposed on lateral surfaces of the camera body 11. The colorimetric sensor 20 measures a color of ambient light in the rightward direction perpendicular to the optical axis. The colorimetric sensor 21 measures a color of ambient light in the leftward direction perpendicular to the optical axis.

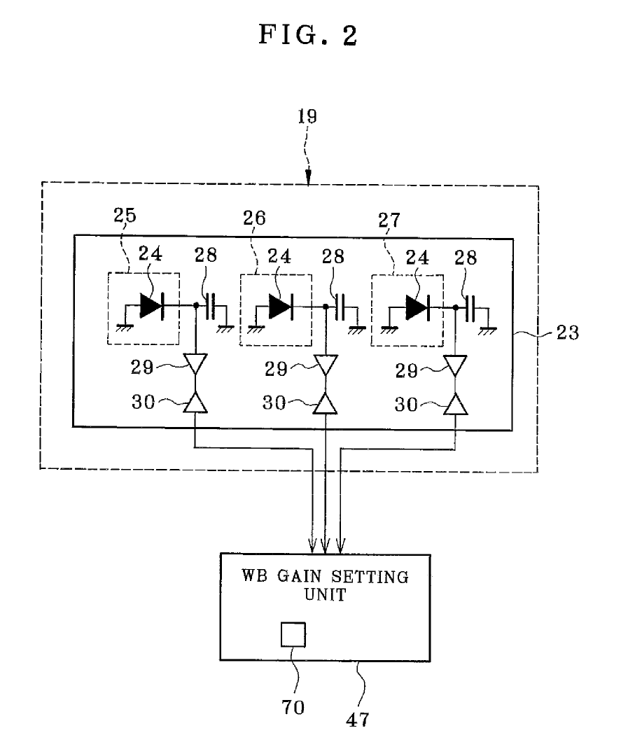

The colorimetric sensors 19-21 are structurally the same. Among those, the colorimetric sensor 19 is depicted in FIG. 2. The colorimetric sensor 19 includes photo diodes 24 as photo receptors or photo sensors, and R, G and B color filters 25, 26 and 27. The photo diodes 24 are disposed on a semiconductor substrate 23. Each of the photo diodes 24 is associated with a floating diffusion (FD) region 28 as floating diffusion (FD) capacitor, a source follower amplifier 29, and an A/D converter 30.

One of the photo diodes 24 behind the R color filter 25 outputs a signal of charge upon reception of ambient light on the upper side with the camera body 11. The charge of the signal is stored in the floating diffusion (FD) region 28, and is converted into a voltage signal according to the stored charge. The voltage signal is amplified by the source follower amplifier 29 in buffer amplification, and is sent to the A/D converter 30. The A/D converter 30 converts the voltage signal into data of a stimulus value of red in a digital form. A WB gain setting unit 47 of FIG. 3 is supplied with the colorimetric data.

Similarly, one of the photo diodes 24 behind the G color filter 26 outputs data of a stimulus value of green. One of the photo diodes 24 behind the B color filter 27 outputs data of a stimulus value of blue. Colorimetric data including those stimulus values are sent to the WB gain setting unit 47.

In FIG. 3, a CPU 35 controls various circuits in the digital still camera 10. When the power source is turned on by depression of the power button 18, a control program is read from a flash memory 36 by the CPU 35. A RAM 37 is loaded with the control program for startup. An input interface 38 includes the mode selector 16, the shutter release button 17 and the power button 18, and generates various command signals. There is a data bus 39 with which the circuit elements of the camera body 11 are connected. The CPU 35 controls those through the data bus 39 upon reception of the command signals.

The zoom lens system 12 includes a variator lens/lens group, focus lens/lens group, and aperture stop mechanism. The variator lens/lens group carries out a change of a focal length by zooming. The focus lens/lens group adjusts the focusing. Motors are associated with respectively the lens/lens groups. A motor driver 41 is controlled by the CPU 35, and drives the motors to move the lens/lens groups.

A CCD image sensor 43 is disposed behind the zoom lens system 12 as a solid state image pickup device. A reception surface of the CCD 43 includes a plurality of photo diodes or photoelectric conversion elements arranged two-dimensionally. Those convert object light photoelectrically when an image is focused on the reception surface. The CCD 43 generates a signal of charge according to an amount of received light for each of photoelectric conversion elements, and produces an image signal by converting the signal of the charge into a voltage signal. Note that R, G and B color filters are associated with the CCD 43 so that each image signal includes red, green and blue components.

A timing generator (TG) 44 generates a clock pulse or timing signal, with which the CCD 43 is controlled. To display a live image, an image signal of a field image, either even field or odd field, is read from the CCD 43. A CDS/AMP circuit 45 is supplied with the image signal. To record an image, an image signal of a frame image is read from the CCD 43, and is input to the CDS/AMP circuit 45.

The CDS/AMP circuit 45 includes a correlated double sampling circuit and an amplifier. The correlated double sampling circuit eliminates a component of electric noise from an image signal, and produces the image signal of R, G and B correctly corresponding to the amount of the charge of the signal. The amplifier amplifies the R, G and B components in the image signal. The WB gain setting unit 47 changes the input gains of the amplifier for each of red, green and blue, for white balance adjustment which will be described later.

An A/D converter 46 is supplied with the image signal from the CDS/AMP circuit 45, and converts the image signal into image data of a digital form. The image data is sent to an image input controller 48 and the WB gain setting unit 47 in which a lighting color temperature detector 70 operates.

The lighting color temperature detector 70 determines lighting color temperature of ambient light around the camera body 11 according to the colorimetric data input by the colorimetric sensors 19-21. The lighting color temperature detector 70 determines image color temperature of object light according to color components of red, green and blue input by the A/D converter 46. The WB gain setting unit 47 sets the input gains of the color components according to the image color temperature and lighting color temperature. Those input gains are assigned to the CDS/AMP circuit 45. A ratio of the weighting factors between the image color temperature and the lighting color temperature of ambient light is set 7:3. Also, components of the colorimetric data from the colorimetric sensors 19-21 are evenly used regarding the weighting factor.

An amplifier in the CDS/AMP circuit 45 multiplies color components of R, G and B of the image signal by input gains assigned by the WB gain setting unit 47, so that the white balance of the image signal is corrected.

The image input controller 48 is connected with the CPU 35 by the data bus 39, and is caused by command signals from the CPU 35 to control the CCD 43, the CDS/AMP circuit 45, the A/D converter 46 and the WB gain setting unit 47.

The CPU 35 and the image input controller 48 are connected with the data bus 39. Various circuit elements are also connected with the data bus 39, including an image signal processor 50, a compressor/decompressor 51, a video encoder 52, an SDRAM 53, a medium controller 54, and an autofocus/auto exposure evaluator (AE/AF) 55. A flash circuit 56 is connected with the CPU 35 as well as the flash memory 36 and the RAM 37, and causes the flash light source 14 to emit flash light.

The image signal processor 50 processes image data in halftone conversion, gamma correction and other image processing, and separates the image data by Y/C separation. Before the image pickup in the image mode, image data of a live image (field image) in the image signal processor 50 is processed in the image processing in a simple setting and Y/C separation, and is stored in the SDRAM 53 temporarily.

Memory regions are defined in the SDRAM 53 for storing a live image of two consecutive field images. While data is read from a first of the two memory regions, data is written to a second of those. The video encoder 52 converts image data read from the SDRAM 53 into a composite signal, to cause the LCD display panel 58 to display a live image.

To start the recording of an image by image pickup, image data of a frame image in the image signal processor 50 is processed in the image processing in the full setting and Y/C separation, stored in the SDRAM 53 temporarily, compressed by the compressor/decompressor 51, and written to the memory card 59 by the medium controller 54.

According to the image data, the autofocus/auto exposure evaluator 55 carries out exposure control to determine optimized exposure, and autofocus control to determine an in-focus position. In the exposure control, a brightness level of the image data output by the A/D converter 46 is integrated for one image frame. A value of the integration is exposure information, which is transmitted through the data bus 39 to the CPU 35. In the autofocus control, a high range component of the brightness level is extracted from the image signal and integrated. A value of the integration is transmitted to the CPU 35 as an evaluation value. The CPU 35 controls the motor driver 41 and the timing generator 44 according to the data from the autofocus/auto exposure evaluator 55, and adjusts the shutter speed and the aperture value in an optimized manner.

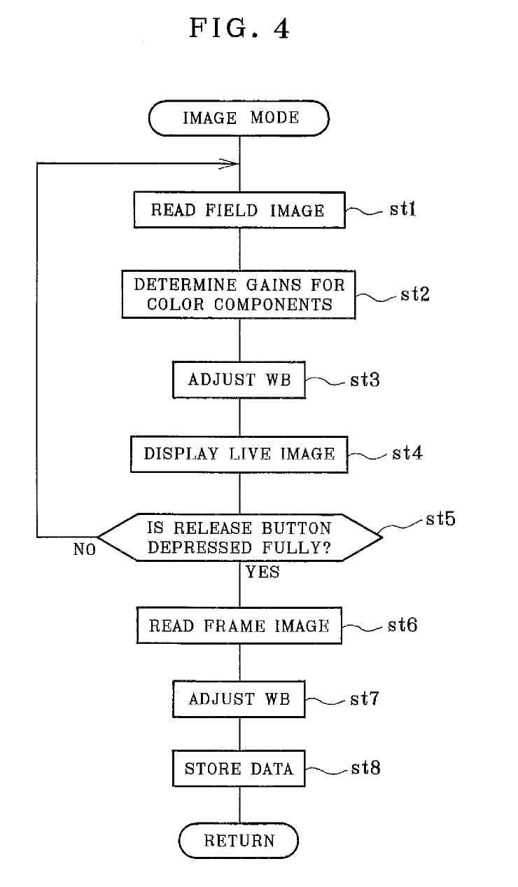

The operation of the digital still camera 10 is described by referring to a flow in FIG. 4. At first, the digital still camera 10 is set in the image mode. An image signal of a field image is read from the CCD 43 at the step st1, and is input to the CDS/AMP circuit 45. A component of electric noise is eliminated from the image signal, which is amplified and input to the A/D converter 46. Then the A/D converter 46 converts the image signal into image data, which is sent to the WB gain setting unit 47 and the image input controller 48.

The WB gain setting unit 47 is supplied with image data and colorimetric data of ambient light on the upper, right and left sides of the camera body 11 from the colorimetric sensors 19-21. The lighting color temperature detector 70 determines lighting color temperature from the colorimetric data of the three directions, and determines image color temperature of object light according to the image data. The WB gain setting unit 47 determines input gains of the color components at the step st2 according to the image color temperature and the lighting color temperature. The input gains are assigned to the CDS/AMP circuit 45.

The amplifier in the CDS/AMP circuit 45 amplifies the color components of the image signal with input gains assigned by the WB gain setting unit 47, and adjusts the white balance at the step st3. The white balance can be adjusted by considering the lighting color temperature in addition to the image color temperature of object light. Even when a person as an object wears clothes of a deep red color or deep blue color, adjustment of the white balance for a color of the image frame can be free from influence of the color of the person. The white balance adjustment is repeatedly carried out at each time of reading an image signal of the field image.

The image data supplied by the A/D converter 46 to the image input controller 48 is processed by the image signal processor 50 for image processing, and is written to the SDRAM 53 in a temporary manner. Then a live image of the image data is displayed on the LCD display panel 58 at the step st4.

When the shutter release button 17 is depressed fully at the step st5, an image signal of a frame image is read from the CCD 43 at the step st6. The CDS/AMP circuit 45 converts the image signal into R, C and B signals, which are amplified respectively with the input gains assigned by the WB gain setting unit 47 to adjust the white balance at the step st7. The input gains are set according to lighting color temperature and image color temperature of object light derived from an image signal of a field image obtained shortly before the full depression of the shutter release button 17.

An image signal after adjustment of the white balance is converted into image data of a digital form by the A/D converter 46. The image input controller 48 sends the image data to the image signal processor 50. The image data is processed by the image signal processor 50 in image processing of various settings, stored in the SDRAM 53 temporarily, compressed by the compressor/decompressor 51, and written to the memory card 59 by the medium controller 54 at the step st8.

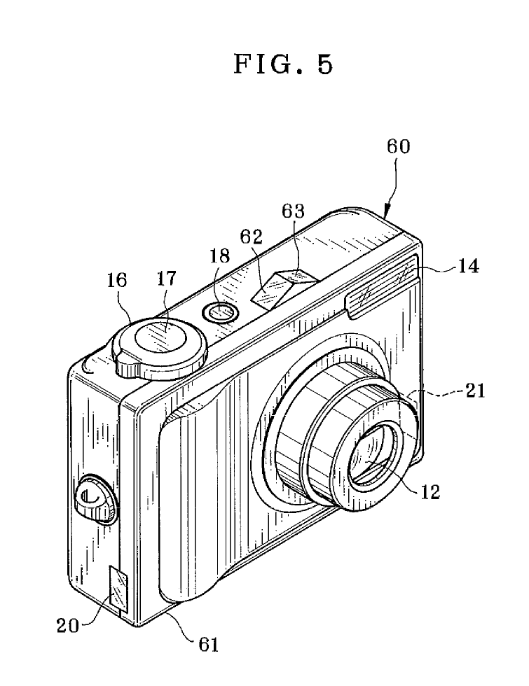

In the embodiment, a reception surface of the colorimetric sensor 19 is oriented exactly upwards from the camera body 11. In FIG. 5, another preferred structure of colorimetric sensors is illustrated. A digital still camera 60 as image pickup apparatus includes a camera body 61 and colorimetric sensors 62 and 63 or calorimeters. Reception surfaces of the colorimetric sensors 62 and 63 are tilted in opposite directions towards lateral sides. This is effective in detecting lighting color temperature of ambient light in a wider region.

Note that in the lighting color temperature detector 70, conversion of colorimetric data into color temperature is carried out according to a method or algorithm known in the art of the color.

In the embodiments, the number of the colorimetric sensors is three or four. However, the number of the colorimetric sensors maybe one or two, or five or more. If only one colorimetric sensor is used, the colorimetric sensor should be positioned on the upper side of the camera body. In the embodiments, a ratio of the weighting factors between the image color temperature of object light and the lighting color temperature of ambient light is 7:3. However, the ratio of the weighting factors can be determined in other suitable manners, for example, 8:2 or 6:4.

In the above embodiment, values of the image color temperature of object light and lighting color temperature are used by weighting. However, other methods of use of the color temperature may be used. For example, an average of the image color temperature and lighting color temperature can be obtained to set an input gain. Also, it is possible for a user to designate a selected one of the values of the image color temperature and lighting color temperature in compliance with visual evaluation of a scene to pick up. In the above embodiments, all of the colorimetric sensors of the camera are used at one time. However, selective use of the colorimetric sensors is possible. A user can select any of those by preference according to a scene with an object of interest.

In the above embodiment, each of the colorimetric sensors includes the three photo diodes. However, it is possible to construct a colorimetric sensor with a low cost type of CCD or CMOS image sensor having a small number of pixels. Also, an image pickup apparatus of the invention may be other articles than the digital still camera, for example, a camera built-in type of cellular telephone, a camera built-in type of PDA (personal digital assistant), digital video camera for motion picture, and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image pickup apparatus comprising:
a solid state image pickup device for image pickup of an image to produce an image signal;
at least one colorimetric sensor for colorimetrically measuring ambient light in a measuring direction being different from a direction of said image pickup of said solid state image pickup device;
a lighting color temperature detector for determining lighting color temperature of said ambient light according to colorimetric data from said colorimetric sensor;
a gain setting unit for determining a gain for each of plural color components according to said lighting color temperature and image color temperature of said image obtained from said color components of said image signal; and
an amplifier for amplifying said color components of said image signal with said gain, to adjust white balance.

2. An image pickup apparatus as defined in claim 1, wherein said measuring direction is substantially perpendicular to said image pickup direction.

3. An image pickup apparatus as defined in claim 1, wherein said colorimetric sensor is constituted by plural colorimetric sensors.

4. An image pickup apparatus as defined in claim 3, further comprising a body for accommodating said solid state image pickup device and said colorimetric sensors;
wherein said colorimetric sensors are positioned on an upper surface and a lateral surface of said body.

5. An image pickup apparatus as defined in claim 3, wherein said plural colorimetric sensors are three colorimetric sensors, and two being included therein and nearer to one another are oriented in measuring directions being substantially perpendicular with one another.

6. An image pickup apparatus as defined in claim 5, wherein said three colorimetric sensors are positioned on respectively an upper surface, a right lateral surface and a left lateral surface of a body.

7. An image pickup apparatus as defined in claim 3, further comprising a body for accommodating said solid state image pickup device and said colorimetric sensors;
wherein said colorimetric sensors protrude from an upper surface of said body, and have surfaces tilted to define a triangular shape.

8. An image pickup apparatus as defined in claim 3, wherein said gain setting unit determines said gain according to a weighted average with a first weighting factor for said image color temperature and with a second weighting factor for said lighting color temperature, and said first weighting factor is greater than said second weighting factor.

9. An image pickup method of image pickup of an image with a solid state image pickup device, to produce an image signal, comprising steps of:
colorimetrically measuring ambient light in a measuring direction being different from a direction of said image pickup of said solid state image pickup device;
determining lighting color temperature of said ambient light according to a result of colorimetry;
retrieving image color temperature of said image according to said image signal;
determining a gain for each of color components according to said lighting color temperature and said image color temperature;
amplifying said color components of said image signal with said gain, to adjust white balance.
